(19) United States
(12) Patent Application Publication
(10) Pub. No.: US 2006/0076168 A1
(43) Pub. Date: Apr. 13, 2006

(54) Modular multi-traction vehicle

(76) Inventor: Guy Gaudreault, Forestville (CA)

Correspondence Address: GAUDREAULT GUY, 26,7e RUE, FORESTVILLE, QC, G0T 1E0, CA

(21) Appl. No.: 11/224,838

(22) Filed: Sep. 14, 2005

(30) Foreign Application Priority Data
Sep. 27, 2004 (CA) 2,479,591

(51) Int. Cl. B62D 55/00

(52) U.S. Cl. 180/9.1

(57) ABSTRACT

This invention relates to a modular track vehicle whose main feature is the possibility of using three types of tracks by changing only two different sets of dead axles while keeping a base configuration and common hydrostatic traction system. The basics elements of this design is a hydrostatic transmission coupled with an internal combustion engine. The cooling system of the hydrostatic driving system is composed of the same components in all cases. The major advantage of this design is that the same frame (1) is used with several types of tracks, specifically: a track completely made of steel (10), a track (11) made of three rubber straps and forged steel cross links, and a track (12) made of rubber reinforced with synthetic fibres.

In the forestry and industrial field, track vehicles are commonly used to accomplish different tasks. Different types of tracks can be used on these vehicles. Three types of tracks are available on the actual market, specifically: a track made completely of steel (10), a track (11) made of rubber straps and forged steel cross links, and a synthetic fibre reinforced track (12). However, in order to use either of these tracks, one must have as many vehicles as there are track types.

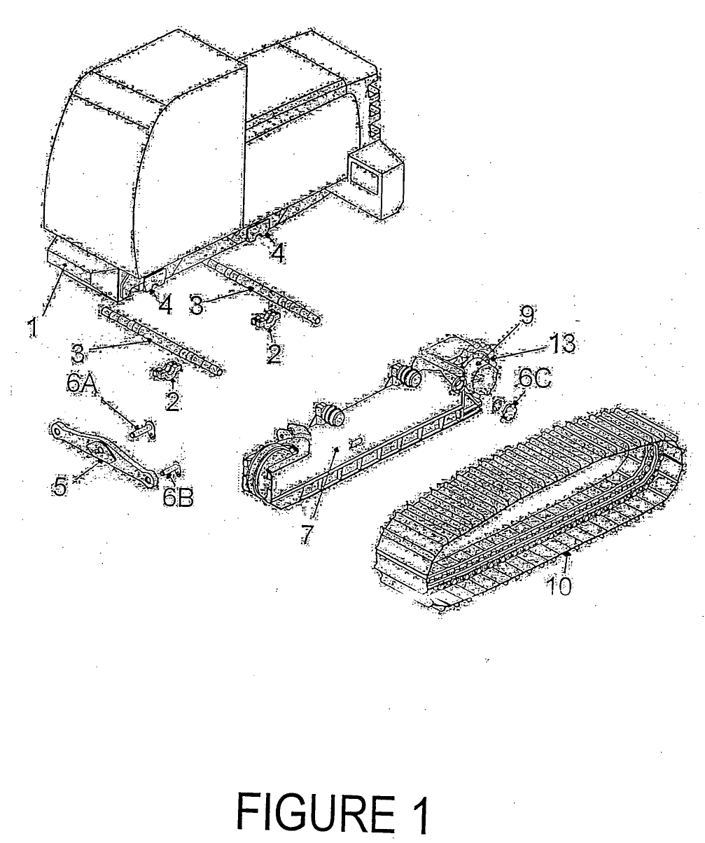

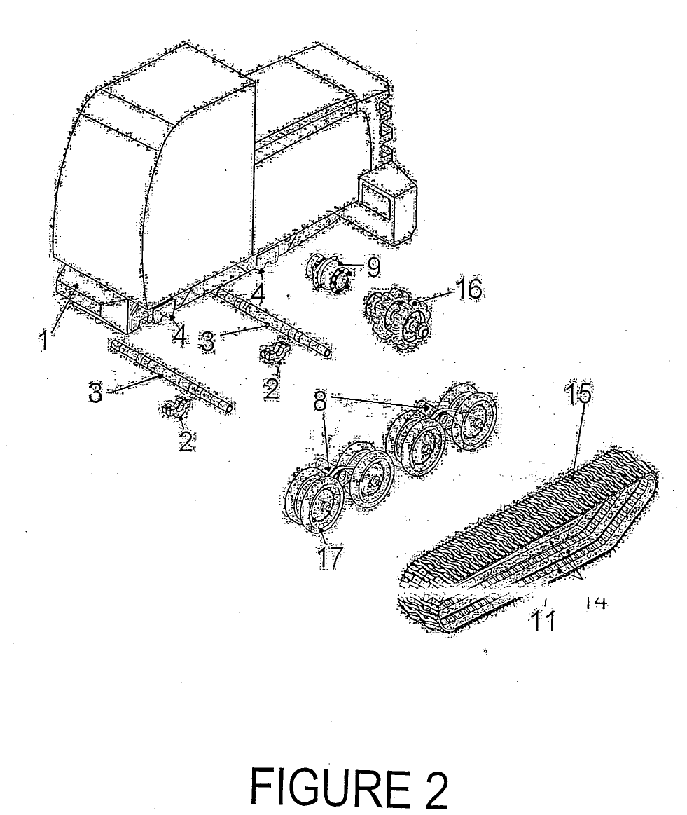

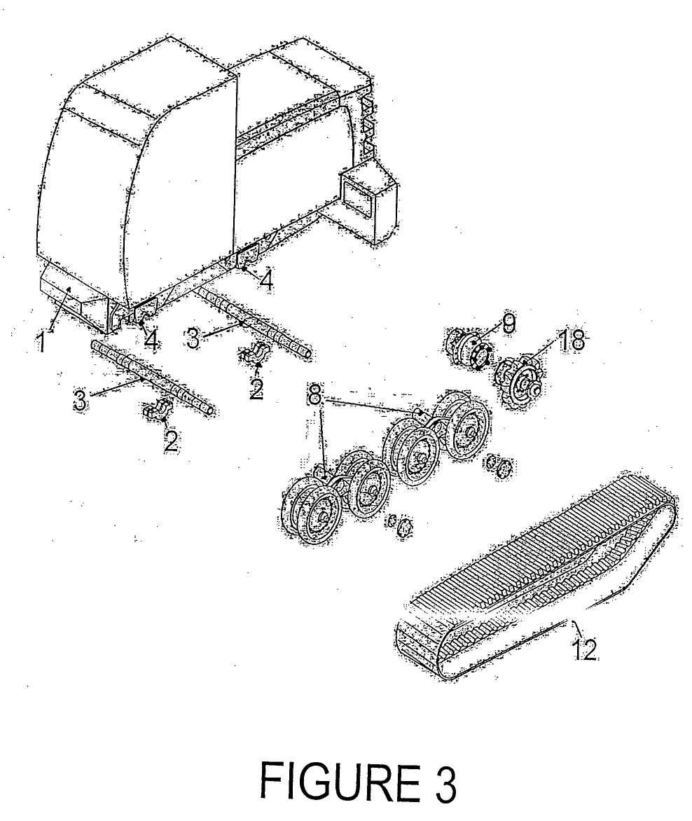

Our invention concerns track vehicles defined as a “multi-traction modular track vehicle”. We propose a motorized vehicle with a common frame (1) and hydrostatic system for the three different traction types. The distinctive feature of this frame (1) is that it shares the load on the two shaft and can receive two shaft models to use different tractions. The principle is simple: in the case where we want rigid traction (FIG. 1), we remove a shaft to insert the cross bar (5) securing it with a pin (6) to the support (4); the support (4) is welded to the frame. The same shaft is used on the two other types of traction, (FIGS. 2 and 3).

The difference between FIG. 1 and FIGS. 2 and 3 is that the cross bar (5) is not added in the case of FIGS. 2 and 3. Of course, the traction frame are different.

Actually, there is no existing frame on the market allowing the use of three different traction types. However, in our search we found that patent #CA2337766 of inventors M. Keith and Vernon E. Gleasman, suggests a universal traction that can be adapted on standard track vehicles. The major inconvenient is that we must have as many vehicles as there are traction types. Moreover this patent indicates only the possibility of being used on a universal traction system, meaning that we can use it on standard frames of track vehicles.

On the contrary, our invention suggests a universal frame (1) that can adapt to three traction types by the replacement of one part to use either traction type listed below.

Track vehicles on the actual market use three different traction types.
The first type is the most used and produced in the world. A vehicle provided with a traction completely made of steel, specifically: a steel track (10) dragged by a steel sprocket (13) and rolling on steel drums. This type does not have any suspension.
The second type is a track completely made of rubber straps (14) reinforced with forged steel cross links (15) dragged by a rubber or urethane sprocket (16), rolling on eight rubber or urethane wheels (17), mounted on two tandem assemblies (8) allowing a certain suspension effect for the vehicle.
The third type is a track completely made of rubber reinforced with synthetic fibre (12) dragged by a metal sprocket made of composite material rolling on plastic or rubber drums and in certain cases theses are mobile to act as a suspension.

For the three traction types mentioned above, there are advantages and disadvantages, namely:
The first type of traction is completely made of steel. This type of traction is efficient for pushing heavy loads at low speeds its track being made of steel chain covered with bolted steel skids. The traction effort provided by this traction type is the most powerful of the three types. However, it is practically impossible to reach average speeds because the operator is limited by the non-existing suspension and is forced to slow down. Moreover, when these vehicles are used at higher speeds the noise of the sprocket on the track links increases dramatically and these two components are easily damaged.
The second type of traction is made of reinforced rubber straps and forged steel cross links. This type can reach average speeds because of its flexible track and suspension. The traction effort provided by this traction type is smaller than the first type but bigger than the third because this track is equipped with heat treated steel crosslink. These cross links are used as a support for the sprocket. The type of suspension used in that kind track is of the tandem type with wheels. The wheels are free to turn around the axis of the tandem assembly. Obstacles and land irregularities are significantly absorbed by the rocking effect of this design. This type has the advantage of having better ground contact allowing it to climb steep inclines.
The third traction type is a rubber track reinforced with synthetic fibre. This type can reach high speeds but the traction effort is very limited because the track is composed exclusively of rubber. The advantage of this traction type is that it does not damage the ground surface which is very appreciated in certain applications.

It is important to remember that environment standard requirements become increasingly demanding and that we are forced to follow certain essential rules to avoid damage to the environment. When the objective is to protect soils, the vehicle is provided with a suspension similar to the second type. In most cases, this type is used for light duty operations. We often find this type of traction on light utility transport vehicles. With this type of traction, vehicles can be used in urban areas, on asphalt roads. One advantage is that the track vehicle can turn around without leaving any print on the paved road. It is very appreciated in urban areas in order to avoid major road damage.

The intent of this invention is to assemble a motorized vehicle that can use the three traction types while keeping the basic configuration and hydrostatic traction system common for the three types of traction. If we examine closely these three types of vehicles, we see that the same components are used under the track. The basic design is a hydrostatic transmission coupled with a internal combustion engine. The cooling system of the hydrostatic system is composed, in each case, of the same components.

Our invention consists specifically to assemble a special frame (1) with common track brackets for the three track types. The modular frame (1), allows to install and use the ideal traction. Moreover, it is possible to install a lifting arm or bucket, depending on the application. This new type of system can be converted as many time as required and allows to reduce the manufacturer's vehicle inventory. The manufacturer and the distributor will have the opportunity to offer the customer a single frame satisfying his needs by installing the most efficient traction for a given application. The customer will not have as many vehicles and the manufacturer will have the added benefit of producing one frame model, modifying only the track desired by the customer. By producing only one frame with the possibility of changing the traction only, the manufacturer will expand his market while reducing the cost of his inventory.

The present invention is described below and is related to the following illustrations:

FIG. 1 illustrates an exploded view of the said type of traction completely made of steel.

FIG. 2 illustrates an exploded view of the second type of the said traction namely: the track (11) made of rubber straps (14) reinforced with forged steel crosslink.

FIG. 3 illustrates an exploded view of the said traction type, namely a track made of rubber reinforced with synthetic fibre (12).

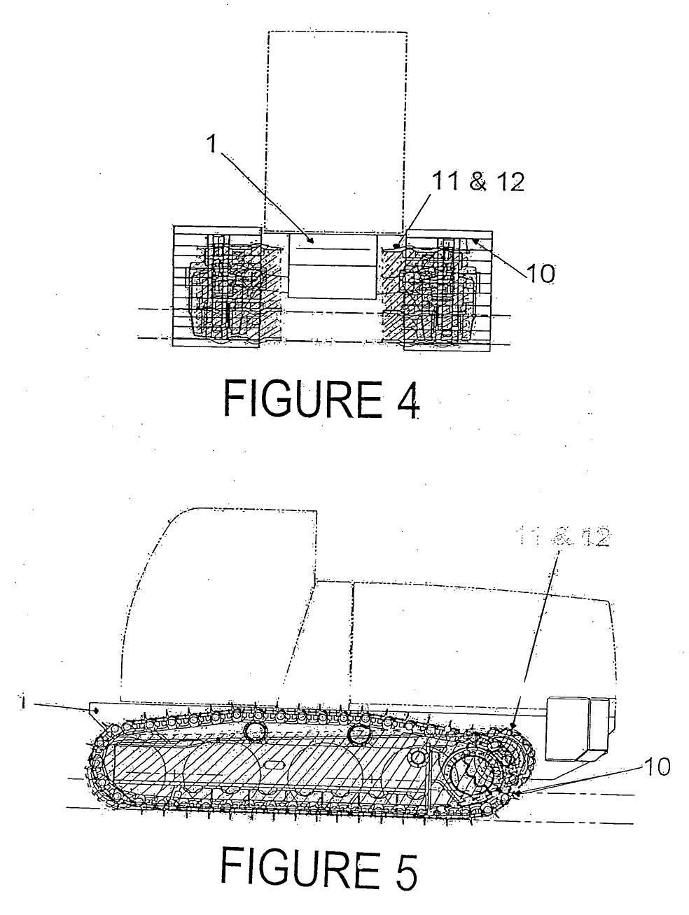

In FIG. 4 illustrating a front view of the machine, we can locate the three types of tracks, namely: the track completely made of steel (10), the track made of rubber straps reinforced with forged steel cross links (11) and finally, the rubber track reinforced with synthetic fibre (12). All these traction types use the same frame (1).

FIG. 5 illustrates a side view of the machine where we can distinguish the three types of track, namely: the track completely made of steel (10), the track made of rubber straps reinforced with forged steel cross links (11) and the rubber track reinforced with synthetic fibre (12). All these tracks use the same frame (1).

In FIG. 1, we can distinguish the different parts required in order to realize the said principle claimed in the present request in relation to the track completely made of steel. We can see a frame (1) and a steel track, that can be installed on the track frame (7). The cross bar is inserted (5) with the holding pin (6) at the axle location. Then, the track frame (7) is set in place with holding pin (6B) and cap (6C) on the axle (3).

In FIG. 2, we see the track (11) made of rubber straps (14) reinforced with steel cross links (15). This track is set on the tandem assembly installed on the axle fixed by pins (2) bolted to the support welded to the frame.

In the FIG. 3, we see a track completely made of rubber (12) set on the tandem assembly installed on the axles (3) fixed by pins (2) bolted to the supports (4) welded to the frame (1).

The installation procedure of the second (11) and the third (12) type of track is the same in both cases, the only difference is the material of the track. To install either the second (11) or the third (12) type of track, the axles must be placed (3) on the supports (4) welded to the frame (1), insert the tandem assembly and bolt it.

In FIG. 4, we have a general front view drawing of the machine, showing the track completely made of steel (10), the track made of rubber straps reinforced with forged steel cross links (11) and the rubber track reinforced with synthetic fibre (12). All these tracks use the same frame (1).

In FIG. 5 we can see a side view drawing of the machine where we can see the superposition of the three types of track of FIGS. 1, 2 & 3; namely, the track completely made of steel (10), the track made of rubber straps reinforced with forged steel cross links (11) and the rubber track reinforced with synthetic fibres (12). These tracks use the same frame (1).

1- A track vehicle propelled by an internal combustion engine coupled with a hydrostatic transmission.

2- A track vehicle, according to the first claim, having a modular steel frame on which all the hydraulic or mechanical components are firmly fixed.

3- A track vehicle, according to the first & second claims, whose modular steel frame is constructed so as to receive, by bolting, the three different types of traction; namely: the track completely made of steel (10), the track made of rubber straps reinforced with forged steel cross links (11) and the rubber track reinforced with synthetic fibre. All these tracks use the same frame (1).

4- A track vehicle, according to the first, second & third claims, whose track driving system (traction motor (9)) can be used for the three types of traction; namely: the track completely made of steel (10), the track made of rubber straps reinforced with forged steel cross links (11) and rubber track reinforced with synthetic fibre (12). All these tracks use the same frame.

5- It is understood that the achievements of the above described claims in reference to the attached drawings, namely FIGS. 1, 2, 3, 4, and 5 are provided for reference and are not subjected to any limitation. Modifications can be carried out without changing the essence of this invention.
